(19) United States
(12) Patent Application Publication
(10) Pub. No.: US 2009/0313352 A1
(43) Pub. Date: Dec. 17, 2009

(54) Method and System for Improving the Download of Specific Content

(76) Inventor: Christophe Dupont, Le Bar sur Loup (FR)

Correspondence Address: CHOATE, HALL & STEWART LLP, TWO INTERNATIONAL PLACE, BOSTON, MA, 02110, US

(21) Appl. No.: 12/164,928

(22) Filed: Jun. 30, 2008

Related U.S. Application Data
(60) Provisional application No. 61/007,540, filed on Jun. 11, 2008.

(51) Int. Cl. G06F 15/16

(52) U.S. Cl. 709/219

(57) ABSTRACT

A method of locating and downloading content from one or more remote servers for access on a client, the method comprising the steps of: identifying one or more key locations on the or each web server which carry out one or more predetermined functions; storing details of the one or more key locations and the associated one or more predetermined functions on the client; causing the web server to carry out one or more predetermined functions on the one or more web server based on the stored details of one or more first key locations and a data entry at the client; using the details to locate one or more key locations on the one or more web servers that come about by means of the causing step; and downloading content from the one or more key locations for access on the local client.

### FIELD OF THE INVENTION

This invention relates to a method and system for downloading content from several internet websites in order to give access to specific files from one or more location and a method of managing the content.

### BACKGROUND OF THE INVENTION

Internet navigators are commonplace and are often used daily by users. The Internet navigators may be used to access information, content or other forms of data. A common use of Internet navigators is to download content such as music, videos, games etc. This may be accomplished by means of an XML HTTP request object which is core part of many asynchronous JavaScript and XML (Ajax) Web applications. However, writing client Web applications that use and XML HTTP object can be problematic given the restrictions imposed by Web browsers on cross domain connections. This is due to the fact that all modern Web browsers impose a security restriction on networking connections which include calls to XML HTTP request. The result of this is that certain scripts and applications are prevented from making a connection to a web server other than that from which the webpage derived. It is possible to enable cross domain requests by means of certain preference settings. Similarly, if both the web application and the XML data come from the same source this restriction does not apply.

Accordingly, a problem exists in serving one web application from another web server, as the web service data requests to the other server are prevented from connecting by the browser. An existing solution to this problem may be to install a proxy on the home web server which makes the XML HTTP requests directly to the other web service. This occurs because the connection is made from the original web server and the data comes back to the original web server and as a result the browser does not prevent the communications. However, for security reasons a proxy should usually be used on a limited basis and an open proxy that passes connections to any website may be open to abuse, so much so that the proxy may become less open and subsequently less useful.

A further solution has been proposed by using a server side proxy which is installed on the web server at a convenient location. To use this web proxy on a client application the web service request is generated as a JavaScript code that does not include the domain name. The domain name is added by the proxy itself on the server side. The proxy can be modified to post process the data from a request on the server side to strip out only the elements of interests. However, if the proxy is used too many times the source of the data comes to recognize the proxy and the server and may block the proxy in the same way as the web browser server above.

Other solutions have been proposed however, all have limited use as a result of restrictions and problems associated with interoperability and security.

### SUMMARY OF THE INVENTION

Accordingly, one object of the present invention is to provide a solution to at least some of the problems associated with the prior art.

A further object to the present invention is to provide an environment where a client can access other servers to download content without the other server blocking the client.

A still further object to the present invention is to provide a method of identifying content in a webpage and accessing that content on subsequent visits to that webpage.

The present invention provides a method of locating and downloading content from one or more remote servers for access on a client, the method comprising the steps of: identifying one or more key locations on the or each web server which carry out one or more predetermined functions; storing details of the one or more key locations and the associated one or more predetermined functions on the client; causing the web server to carry out one or more predetermined functions on the one or more web server based on the stored details of one or more first key locations and a data entry at the client; using the details to locate one or more key locations on the one or more web servers that come about by means of the causing step; and downloading content from the one or more key locations for access on the local client.

### BRIEF DESCRIPTION OF THE DRAWINGS

Reference will now be made, by way of example, to the accompanying drawings, in which:

FIG. 1 is a block diagram of a system for downloading and managing access to content, in accordance with an embodiment of the invention, given by way of example.

FIG. 2 in a schematic diagram to demonstrate a tree structure applied to a webpage to enable content to be identified and accessed, in accordance with an embodiment of the invention, given by way of example.

FIG. 3a is an example of a mask definition for a particular webpage, in accordance with an embodiment of the invention, given by way of example.

FIG. 3b is an example of a simple mask definition for a particular webpage, in accordance with an embodiment of the invention, given by way of example.

FIG. 3c is example of a complex mask definition for a particular webpage, in accordance with an embodiment of the invention, given by way of example.

FIG. 3d is an example of implementation of plug-in on a page.

FIG. 3e is an example of HTLM tag.

FIG. 4 is a flow chart of the method steps associated with identifying content on a webpage, in accordance with an embodiment of the invention, given by way of example.

FIG. 5 is a flow chart of the method steps associated with subsequently accessing content on a webpage, in accordance with an embodiment of the invention, given by way of example.

FIG. 6 is an example of a web page for carrying out a search, in accordance with an embodiment of the invention, given by way of example.

FIG. 7 is an example of a web page for presenting the results of a search, in accordance with an embodiment of the invention, given by way of example.

### DETAILED DESCRIPTION OF THE PREFERRED EMBODIMENTS

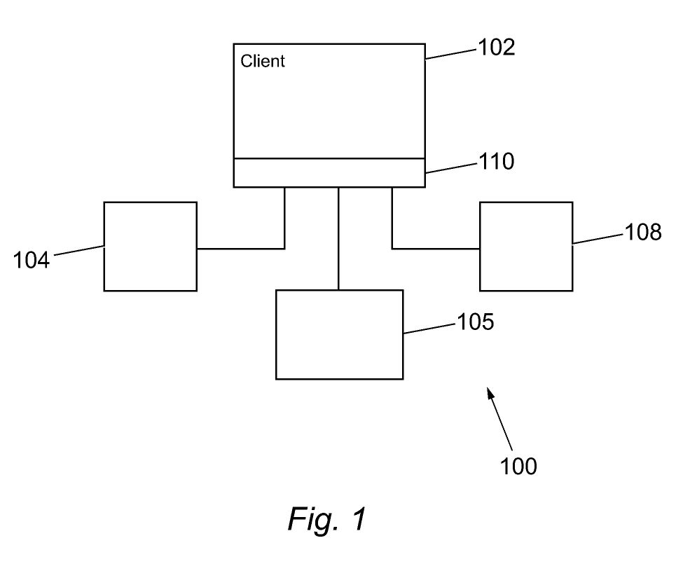

Referring initially to FIG. 1 a block diagram of a system 100 is shown. The system includes a local computer or client 102 connected to a plurality of remote web servers 104, 106, and 108 located at some point in the Internet network. The client may be connected to many other web servers and three are shown as an example in this figure. The client also includes a plug-in 110 which carries out many of the functions of the present invention as will be described in greater detail below. One function carried out by the plug-in 110 is to act as a proxy server for the client. As the proxy is associated with the client, overuse of the proxy is unlikely to become a problem when accessing other web pages. The function of the plug-in is to act as a link between the client and other servers to enable download of content, for example music, videos, etc. In order to do this the plug-in establishes a mapping of the web page from which the content is to be downloaded. The plug-in may be in the form of a tool bar, an activeX controller or any other appropriate form, including stand alone application. In other words, the functional elements may be either in or not in the plug-in.

In case a navigator does not comply with existing plug-ins and exists as a stand alone option, it may be necessary to use a chain of proxies. This avoids sending many requests from only one client (i.e. proxy) and then being forbidden access. Requests received by the first proxy will be sent to a second proxy. The second proxy will effect requests to the remote sites, thereby disguising the first proxy.

The mapping occurs with respect to any type of pages, for example search and results pages so that the location of content both with respect to entering data and downloading content is mapped prior to a search being carried out. The result of the mapping is that for a given instant in time the plug-in and hence the client knows the location of the webpage of the particularly content that is being sought. This will be described in greater detail below. The mapping can be of any appropriate type and an embodiment presented herein involves determining the tree structure for each and every webpage from which content is sought.

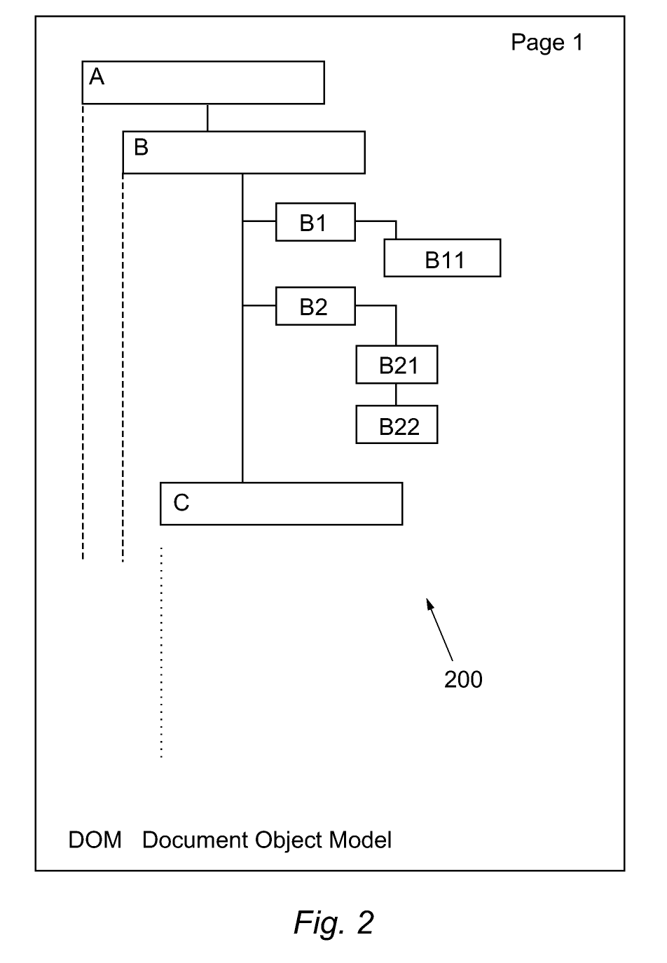

Referring to FIG. 2 an example of a tree structure is shown generally at 200 for web page on a remote server (e.g. a remote web page or remote page) (page 1). A typical web page is made up of a number of web elements, fields, frames, etc. which are located at different locations throughout the web page. The different web elements may be presented on the page in terms of headings, subheadings, sub subheadings, content etc. For example, in FIG. 2 block A may be a heading; block B a subheading; blocks B1 and B2 sub subheadings; and blocks B11, B21 and B22 may be content. The tree is in the form of a Document Object Model (DOM) and known as an XML Tree. This works on the basis of a Cascading style sheet (CSS) and is a model used to apply style to documents such that a selector may find an element e.g. BI or block A etc. In accordance with the present invention each of the web elements are located in a particular location and their position relative to other web elements is determined in order that the linkage between headings, subheadings and content can be identified. Then each Web element is allocated a mapping address which relates to its original starting position on the webpage and is an indication of the relative linkage between successive web elements. For example block A may have a first mapping address whilst block B may have a different mapping address. It should be noted that the actual position of the objects and blocks on the presented page may not be as shown in the XML tree or DOM.

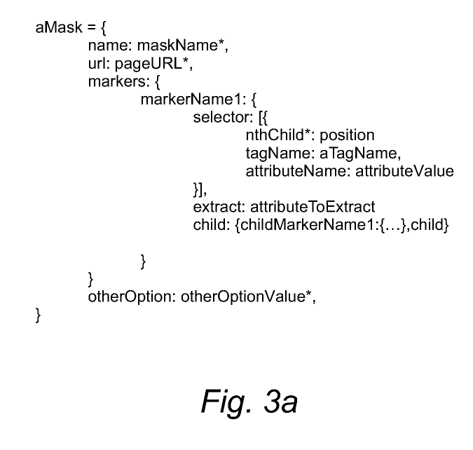

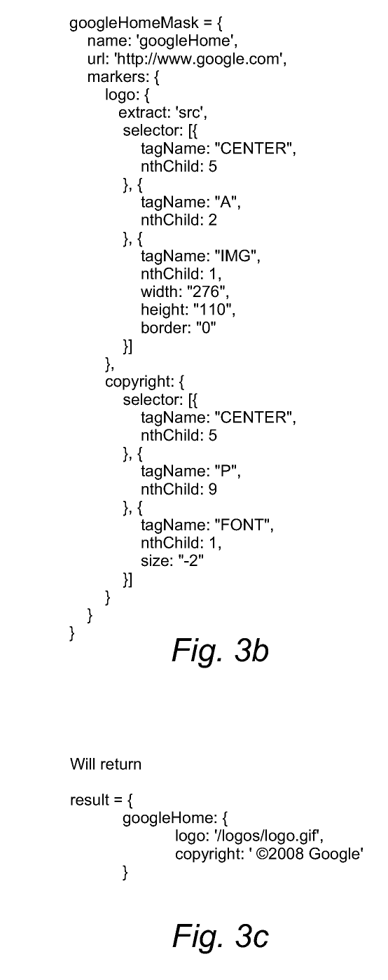

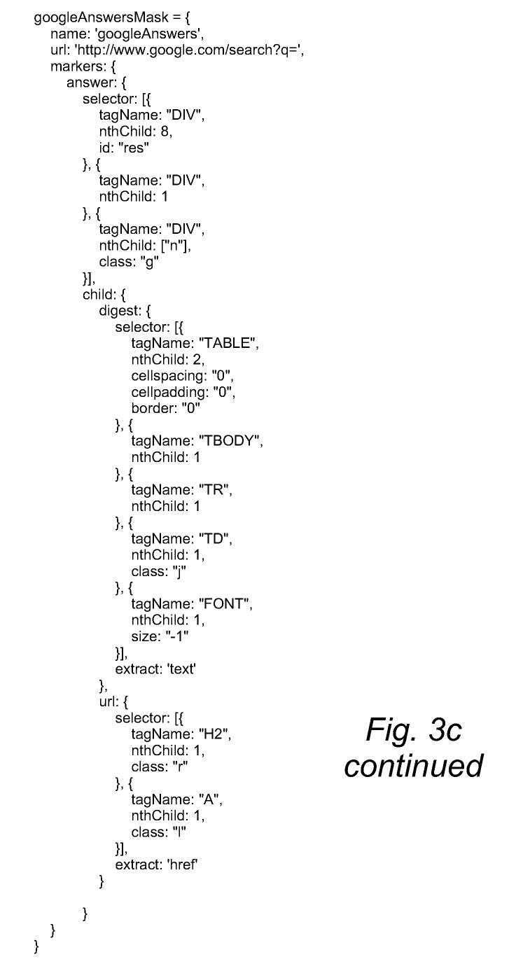

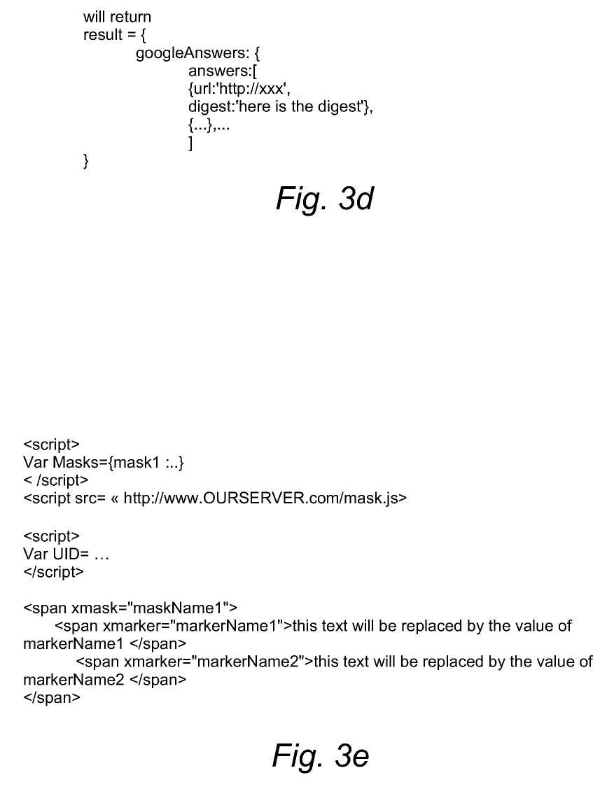

The following describes an example of the mapping of each web element on the page. This particular methodology of mapping address and tree structure is only one example of a method of identifying web elements on a web page. There may be many other alternative methods, for selecting areas with a mouse generating a marker. The position of the marker is stored and a page is loaded into a cache until the data is required. One manner in which the mapping is accomplished is referred to as Mask definition and proceeds in accordance with the code shown in FIG. 3a, where

maskName: (string) name of mask

markerName1: (string), name of marker

position: (integer or string or array of position) If position is an integer position of the element in the child descendance.

If position is a string (ex: “2n”) then it will match all integers of this type (ex: 2, 4, 6 . . . )

If position is an array, it will match any of each array element.

aTagName: (string) tag name of the element.

attributeName: (string) any element attribute,

attributeValue: (string) value of the attribute.

attributeToExtract: (string) value of the attribute to extract.

If not set: extract all HTML string inside the element.

If set to text: extract only the text inside the element without HTML.

otherOptions: (string) other option to be used by the mask extractor.

otherOptionsValue: (any type) value of the option

ex: styleSheets: (Boolean) return an array of href of stylesheet files
setStyle: (Boolean) put style attribute in any returned element in order for the resulting mask to be displayed as in the original page
childMarkerName1: (string): when child option is present, extract all markers in every occurrence of parent marker
selector is to be applied from the element of the parent marker.

Any variable without the * are optional variables. An example is shown in FIG. 3b. The tags can be set on web pages as follows: Firstly it is necessary to determine a tag script to insert the tag. These may be stored on the server and defined by an editor at an earlier point. Then in order to display the external page on the host page this is accomplished by the, for example: —
downloading the data display:
using HTML new tags as shown in FIG. 3e and
using a call-back function which receives the variable comprising the values of the tags.
   The call back function can be replaced by appropriate alternatives

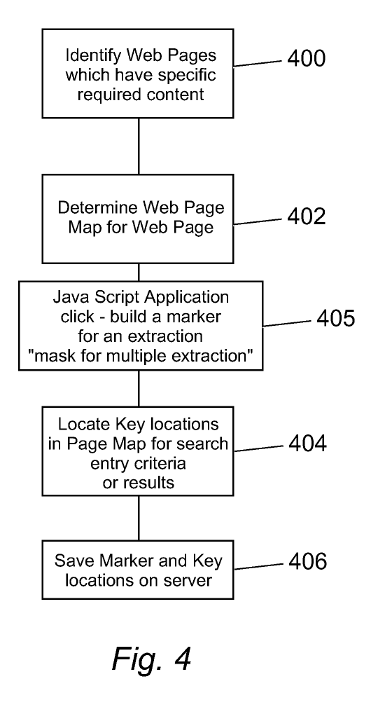

The chosen method of identifying web items on a remote web page is used by the plug-in in order to allow the client to carry out a search, for example, for specific content via a number of other websites. This works in the following way with reference to FIG. 4. Firstly an Editor determines the likely remote web pages which might include the specific content the client may wish to locate step 400. For example, if the client is to be used to download music content the likely remote web pages are those which include music content. The Editor may store details in an appropriate memory location of the likely remote pages for a specific type of content. This may be in the form of a database which grows as the client carries out further searches for different types of content. In addition, the Editor may provide a means by which the user can indicate the type of content required at that instant, for example by means of a button, data entry box, drop-down menu or other selection means.

Once the type of content and the relevant remote web page or pages have been identified, the Editor determines a webpage map for the or each remote web page (step 402). If the remote web page has been identified in the past the map may already be stored in the database and the Editor merely needs to access the map from the database. However, if the Editor has not contacted the remote web page before, or the remote web page has changed since the last visit the mapping of the elements located on the remote web page may be defined (or redefined). In the examples used to describe the process, but not intended to be limitative, searching and results are functions which are employed. Other functions may include: construction of a personalised page with personalised content; mail presentation from multiple mail accounts, etc. In this first part of the process the elements on the webpage are those by which search criteria can be entered for example the dialog box into which the search criteria would normally be typed on the web page. It will be appreciated that a remote server may have several web pages, for example a search entry page and a results page etc.

The mapping process generally locates all web elements on the web page and then by a further process locates the key locations in the mapping that relate to, for example, the search entry criteria. This is illustrated in FIG. 4 as step 404. The manner in which the further process locates the key locations is determined by markers or tags. For the search page a first set of key locations may be determined. For subsequent pages on the same remote server a second, third etc. set of key locations may be determined. A set of key locations can include one key location. Each location is associated with a particular function on the remote server or remote web page. For example, the particular function may be display, data entry, activation, or any other appropriate function.

Mask Definition

The plug-in includes an interface for creating tag or a mark indicating a key location. There are typically two different types of tags: a simple tag, which can extract one or more zones which are unique in a page; and a complex tag, which can extract several zones of a page and also certain sub-zones useful for extracting information such as list of responses in zones to be completed etc. The tags are created as follows:

In the navigator the user writes the page address and chooses the zones to extract with his mouse or other appropriate selection means. The user can extend this zone to create complex tags as follows: the user creates several simple tags which represent different possibilities (or responses) for the zone to be completed. The user merges the simple tags into a complex tag by removing certain parameters which vary as described below. If more than three tags are merged, the parameter nt Child will be generalized such as “2n+1”. Similarly, the creation of markers is shown with respect to FIG. 3e.

Once the mapping and the key locations have been identified these may be stored at an appropriate location (e.g. a Client computer or Editor server etc.) on the client either in the database or any other appropriate environment (step 406). At any time the client or Editor accesses a remote web page in order to determine the map, or for further functions that will be described in detail below, a check may be made to determine whether there are any changes to the remote we page layout by surveillance on a server which is generally not part of plug-in. The result of the process as described, by way of example in FIG. 4, is a mapping of remote web page which may have the specific required content including appropriate tags and markers to enable identification of a number of key locations on the (or each) web page for entry of, for example, search criteria or for any other purpose. The mapping and/or the key locations are stored so that the client and/or the plug-in can identify the location of the key locations on the remote web page for further processes and functions. Similarly, a mapping and identification of key locations is carried out for any results page that may result from a search on a remote web page. In this way, the location of any particular result fields, for example to download a particular content such as the song, can be determined for future use by the local plug-in. The mapping and identification of key locations in the remote results page is similarly stored at an appropriate location in the memory or database on the client. In other words, the web page for searching, for example, on Yahoo web search engine is stored with a mapping, in accordance with the present invention on the appropriate location along with the locations of a first set of key locations on that page. Also stored with the search page for Yahoo is a results page for Yahoo which identifies the locations of the search results, in particular, and other elements if required as a second set of key locations.

Thus, by entering search criteria into the client these can be transferred to the remote search page for Yahoo by the plug-in. After the search on the Yahoo webpage has been completed the plug-in can access the remote results at the second set of locations of the Yahoo results page based on the locally stored key locations for that remote results page. For a particular type of content the search and result pages of multiple remote web pages may be stored, so that multiple remote pages can be accessed for search for a specific content from the appropriate location.

The determination of the key location tags and marks may be customisable by the user or any other party to provide alternatives.

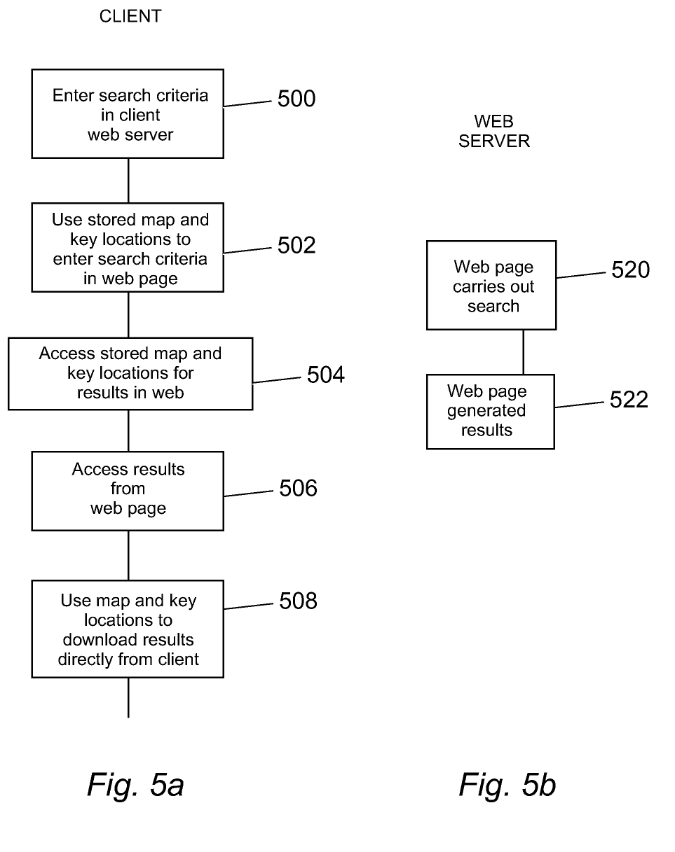

At some point after the process of FIG. 4 has been carried out a user of the client may wish to access content of a particular type relating to a particular set of search criteria. The process, in accordance with the present invention, then proceeds as follows with reference to FIG. 5. The type of content is identified and optionally the correct types of remote web pages are identified from the database or otherwise. For example, if the user wishes to search for music by a particular artist or for a specific album the correct type of relevant remote web pages are those which relate to music. Similarly, if the user is searching for a film or a particular actor the correct types of remote web page will relate films or movies.

It should be noted that the plug-in may work for all types of application e.g. searching a personal web page, content aggregation etc and the invention is not limited to searching and the display of results as used as an example to aid comprehension herein.

At the step 500 the user may then enter the specific search criteria at an appropriate location in the local web server. For example, the user may enter the name of a favourite performer or group. The plug-in then accesses the stored mapping, key locations and tags in order to determine the location of the key locations on the remote web site server. In other words, in the example the plug-in determines the location of the remote dialog box into which the search criteria would be typed in the remote web page. The plug-in then enters the search criteria which have been entered into the client into the search dialog box of the remote web server (step 502).

The remote web page is then requested to carry out the required search as is illustrated in step 520. This and the following step 522 take place at the remote server of the remote web page. At step 522 the remote web page which contains relevant content generates a remote results page.

Meanwhile, at the client the plug-in accesses the stored mapping and key locations for the results page of the remote web page. This identifies the key locations, for example the remote results field of the search. The plug-in then accesses the remote results from the web page which contains the relevant content, step 506. Then using the map and key locations the plug-in downloads the remote results from the remote web page and displays them directly on the client as illustrated by step 508. In addition, the plug-in may access a number of remote web pages where the require content can be found. In this way, the results from a number of remote web pages can be displayed on the client without having to access multiple remote web pages or web servers independently.

It should be noted that although not shown there will be communication between the client and remote or web server as appropriate for communication therebetween.

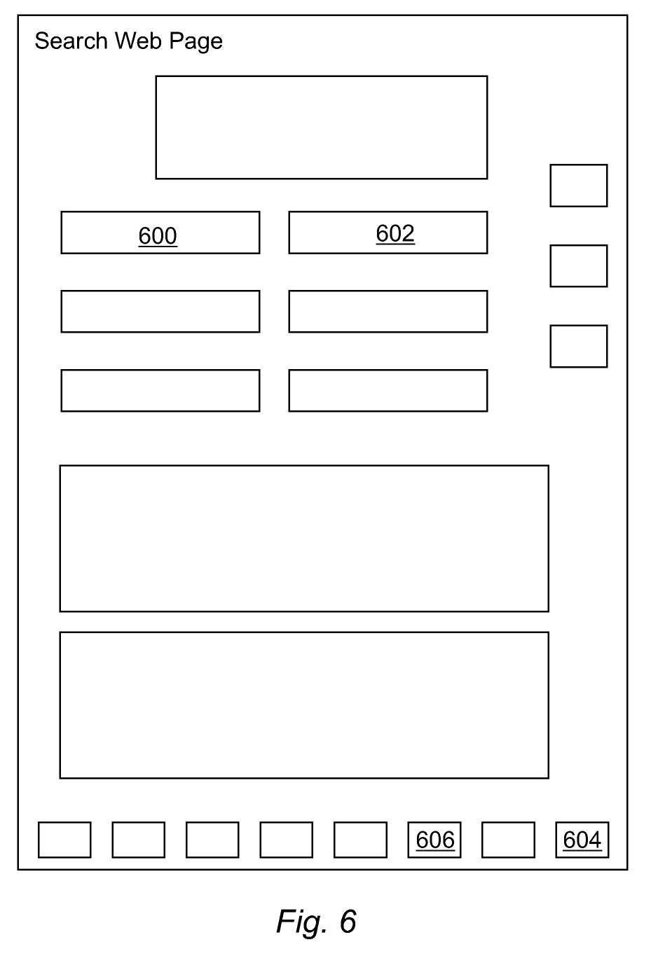

FIG. 6 shows an example of a remote web page for carrying out a search. In the process demonstrated with respect to FIGS. 4 and 5 the key locations located and used by the plug-in of the present invention may be the remote dialog search boxes for example as shown as 600 on FIG. 6. There may also be a remote button, for example location 602, which is activated after the search criteria are entered into box 600 to launch the search. In order to search on the remote web page shown on FIG. 6 the client or plug-in needs to know specifically locations 600 and 602. In other examples, where the plug-in is being used to carry out actions other than a search, key locations may be different. For example, if the client wishes to have access to the Webmaster of the remote web page or access contact information there from, the key locations may be boxes 604 and 606 respectively. For access to different types of content the key locations of a remote webpage may be different and the different key locations may be stored with respect to the different types of content in the memory at the client. For determination of the key locations for access to each different type of content the same mapping may be used but the determination of which are the key locations will clearly be different.

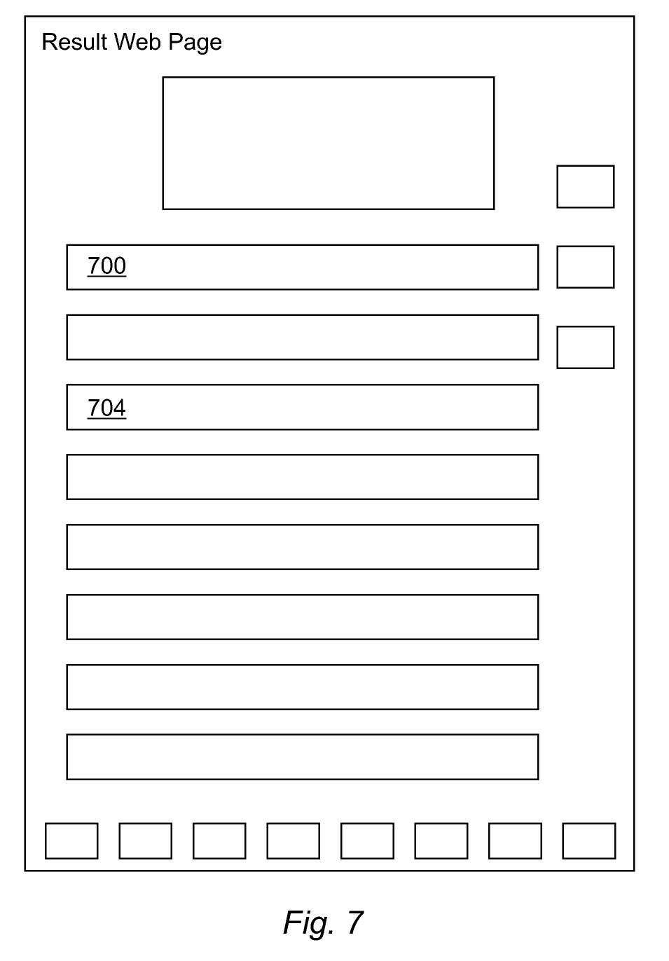

FIG. 7 shows an example of the layout of a remote results webpage. Through the process of the present invention the local plug-in determines the location of the remote result fields 700, 702, 704 etc. as the key locations. The key locations can then be accessed at any time the user has searched a remote web page and a results page has been produced. If the display of the external page changes, it is possible to keep the link between the tag and the information associated with this tag by storing tags in the server and defining specific requests at the start where some responses are already known and/or where some responses will never change. Any rebuilding of the invariable parts will be rebuilding of the tags.

The results from multiple pages may be consolidated in any appropriate manner, for example if five remote web pages are accessed, the results may be presented as the first from each page followed by the second and so on. The plug-in may include a comparator which can compare the results and delete duplications. Alternatively, if one remote website is known to give better results all the results from this remote page may be displayed first on the client. For example, by comparison of each result with the others by means of tags, markers, etc.

The invention provides a security process which proceeds as follows:

At each request for downloading a mask, the plug-in checks with a control server if the access to an external page is allowed from the host page. Without any authorization, the access will be denied. A “cache” system is provided to avoid requesting the authorization if the answer is already known from before. After this the plug-in sends, for example, three parameters to the server, these may be:—

the url from host page comprising the script;

url of the page the script wants to access; and

the or a checksum of the code of the host page sent to validate access.

The server returns parameters in the form of the HTTP header: (where http “status code” (integer): code 200 means an accepted authorization or code 40X means a refusal.) or other headers: for example,
From: url (string) which is allowed to execute requests;
To list of url (array of string) allowed to execute requests;
Expire (string): date of expiration of authorization; and
PageAccess (boolean): to specify if the content is reachable with or without any mask
   In addition the Editor for plug-ins may require to be validated to prevent access to sensitive information in certain hosts.

It will be appreciated that different types of process can be carried out in order to effect the present invention. In a preferred embodiment the key locations are located by means of a mapping and key location identification process. However, a different means of identifying the key locations on a remote web page are equally relevant to the present invention.

What is important is that the present invention enables a highly efficient and practical means and method of content management. Content can be selected from multiple sources and concatenated together to be displayed in a user defined manner.

1. A method of locating and downloading content from one or more remote servers for access on a client, the method comprising the steps of:
identifying one or more key locations on the or each web server which carry out one or more predetermined functions;
storing details of the one or more key locations and the associated one or more predetermined functions on the client;
causing the web server to carry out one or more predetermined functions on the one or more web server based on the stored details of one or more first key locations and a data entry at the client;
using the details to locate one or more key locations on the one or more web servers that come about by means of the causing step;
downloading content from the one or more key locations for access on the client.

2. The method of claim 1, further comprising: —
identifying one or more web servers which include a predetermined type of content required by download.

3. The method of claim 1, further comprising forming a representation of key location by use of a plug-in to enable access to the content.

4. The method of claim 1, further comprising displaying downloaded content in a predetermined manner.

5. The method of claim 1, further comprising determining a mapping of the or each key location on a web page to enable access to content at the or each key location.

6. The method of claim 1, further comprising identifying key location by means of a marker or tag.

7. The method according to claim 1, further comprising locating key locations on multiple web servers to obtain content for display.

8. The method of claim 7, further comprising reading a marker or tag associated with the content for display and comparing the marker or tag to avoid displaying duplicate content.

9. The method of claim 1, further comprising storing a mapping of one or more web pages.

10. The method of claim 9, further comprising accessing the stored mapping to determine key locations on the or each web page.

11. The method of claim 9, further comprising updating the mapping for the or each web page where changes occur.

12. The method of claim 1, further comprising generating a user defined set of content for display.

13. A computer program comprising instructions for carrying out the method of claim 1, when the computer program is executed on a computer system.
